(19) United States
(12) Patent Application Publication
(10) Pub. No.: US 2008/0013087 A1
(43) Pub. Date: Jan. 17, 2008

(54) Alignment form

(75) Inventors: Mark M. Bailey, Burnet, TX (US); Steven J. Zielnicki, Round Rock, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/486,506

(22) Filed: Jul. 14, 2006

(51) Int. Cl. G01B 11/00

(52) U.S. Cl. 356/399

(57) ABSTRACT

A chassis having an alignment form is disclosed. The alignment form has dimples that permit a carrier to be aligned with the chassis sidewall. When a component is inserted in the computer system, the component contacts the dimples and aligns in the chassis sidewall.

### TECHNICAL FIELD

The present disclosure relates generally to computer systems and information handling systems, and, more particularly, to an alignment form for a chassis for a computer system or information handling system.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

An information handling system or computer system may include a hard drive that is coupled to the chassis of a computer or a drive bay. A hard drive is typically disposed on a carrier assembly, often referred to as a hard drive carrier, and the carrier assembly is inserted, via a guide rail system, into a bay in a computer chassis. The hard drive carrier serves as a protective housing for the hard drive and mechanically mates with a drive bay in a computer chassis.

### SUMMARY

In accordance with the present disclosure, an alignment form and a method of manufacturing the alignment form are disclosed. The alignment form includes one or more dimples formed in a chassis or other structure. In the chassis, the dimples contact a carrier as it slides into the chassis. When a component, such as a removable hard drive, is inserted in the carrier, and the carrier is inserted in the chassis, the carrier contacts the dimples of the alignment form and is aligned.

The alignment form disclosed herein is advantageous because the carrier and chassis provide a technique for securing one or more carriers of the computer system during the assembly or servicing of the computer system. The dimples may be formed directly into the chassis sidewall, and are not a separate part that has to be installed into the system. This may reduce assembly and part costs.

Another technical advantage of the alignment form disclosed herein is that the alignment form is compact, thus reducing spatial requirements. This reduction in space needed may maximize the number of carriers that are able to be arranged on the system. Additionally, the alignment form may allow for smooth insertion and removal of the carrier.

Yet another technical advantage of the carrier and chassis disclosed herein is that the alignment form may be formed at a single station in the manufacturing die. This may optimize tolerance stack-ups and allow for a favorable mating condition between the hard drive and the backplane. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a pictorial view of a chassis sidewall;

FIG. 2 is a pictorial view of a chassis;

FIG. 3 is a front view of a carrier in a chassis;

FIG. 4 is a front view of a carrier in another chassis;

FIG. 5 is a cross sectional view of a dimple; and

FIG. 6 is a pictorial view of a server top cover latch.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device, and may vary in size, shape, performance, functionality, and price. The information handling system may include random access memory (RAM), one or more processing resources such as a central processing unit (CPU) or hardware or software control logic, read-only member (ROM), and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

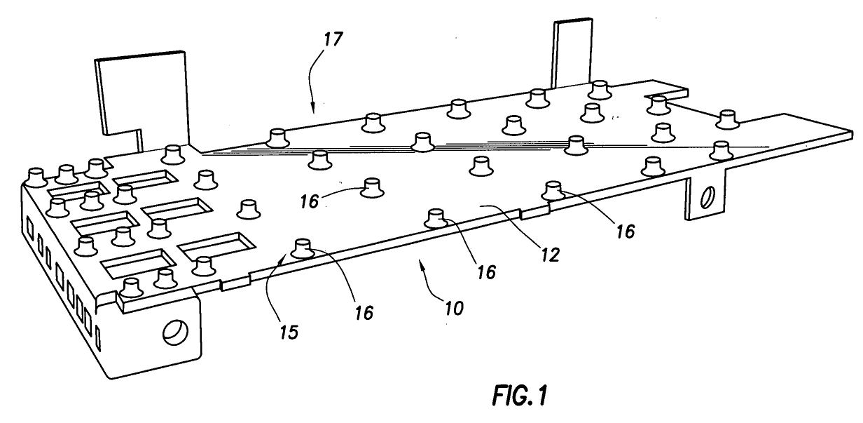

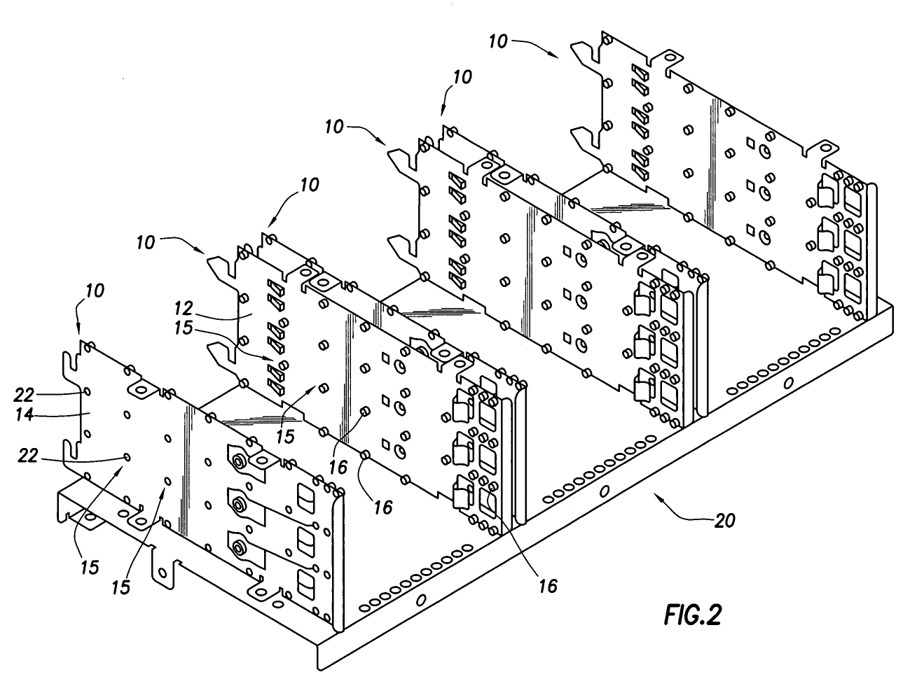

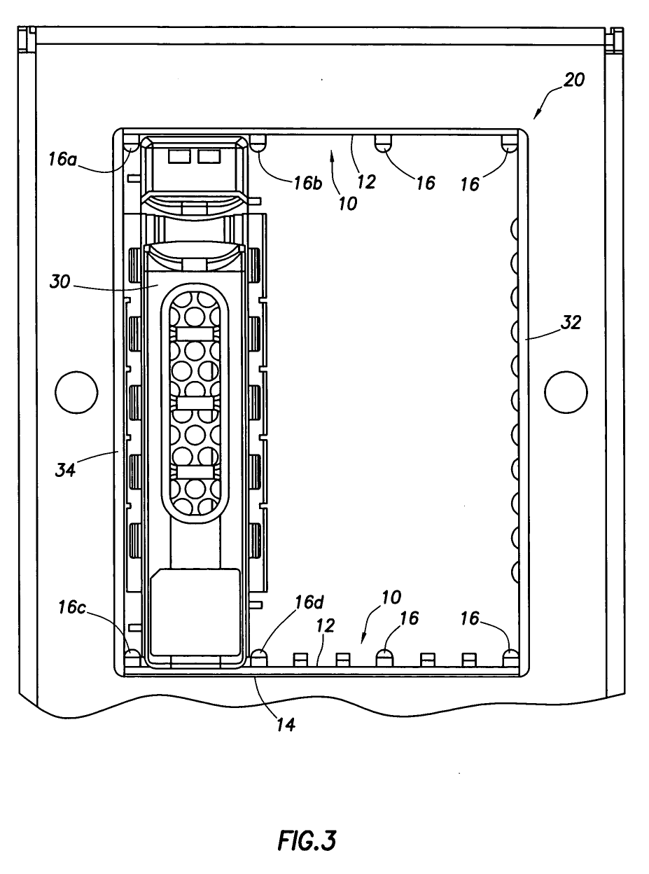

Shown in FIG. 1 is a pictorial view of a chassis sidewall 10 of a chassis 20 (shown in FIG. 2). Chassis sidewall 10 includes alignment dimples 15, which extend from a front face 12 to a rear face 14 (shown in FIG. 2). Multiple dimples 15 cooperate to form an alignment form 17. On the front face 12, the dimples 15 form protuberances 16. On the rear face 14, the dimples 15 form recessions 22 (shown in FIG. 2). The protuberances 16 on the front face 12 provide guidance to a carrier 30 (shown in FIG. 3) as it slides between two or more chassis sidewalls 10. The formation of the dimples 15 in the chassis sidewall 10 may reduce or eliminate the separators that are typically required for alignment.

The dimples 15 are sized to minimize surface area in contact with the carrier 30, allowing for smooth insertion and removal of the carrier 30 from the chassis 20. For example, the dimples 15 may be rounded, such that only a finite portion of the protuberances 16 contact the carrier 30.

Shown in FIG. 2 is a pictorial view of the chassis 20 having six chassis sidewalls 10. However, any number of chassis sidewalls 10 may be used to maximize the number of drives. Unlike the front face 12 of the chassis sidewall 10, the rear face 14 does not include any protuberances 16 and is substantially planar. The dimples 15 form the recessions 22 in the rear face 14.

Shown in FIG. 3 is a front view of a carrier 30 in the chassis 20 of a computer system. In the example of FIG. 3, chassis 20 includes chassis sidewalls 10, and front faces 12 of the chassis sidewalls 10 are visible. The protuberances 16 on the front face 12 are shown exposed and readily accessible. The carrier 30 fits between the protuberances 16. More specifically, protuberances 16a, 16b, 16c, and 16d assist in the alignment of carrier 30 shown in FIG. 3. Additional carriers (not shown) may be aligned using protuberances 16 formed by additional dimples 15. While FIG. 3 shows additional walls 32, 34 and protuberances 16 for aligning three carriers, different configurations may allow for any number of carriers, maximizing the number of hard drives.

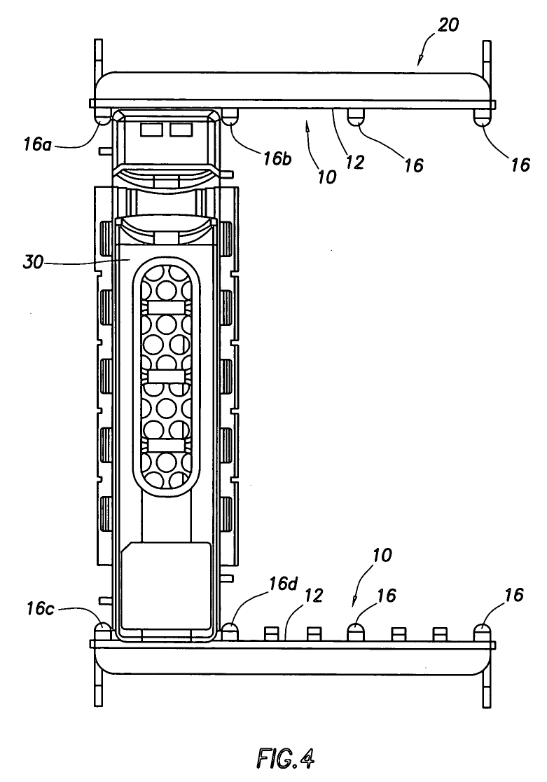

In FIG. 4, the additional walls 32 and 34 illustrated in FIG. 3 are absent. This allows the chassis sidewalls 10 to be sized to receive any number of hard drives. While the configuration of the chassis 20 of FIG. 4 is slightly different, the function of the protuberances 16 is similar to that of FIG. 3.

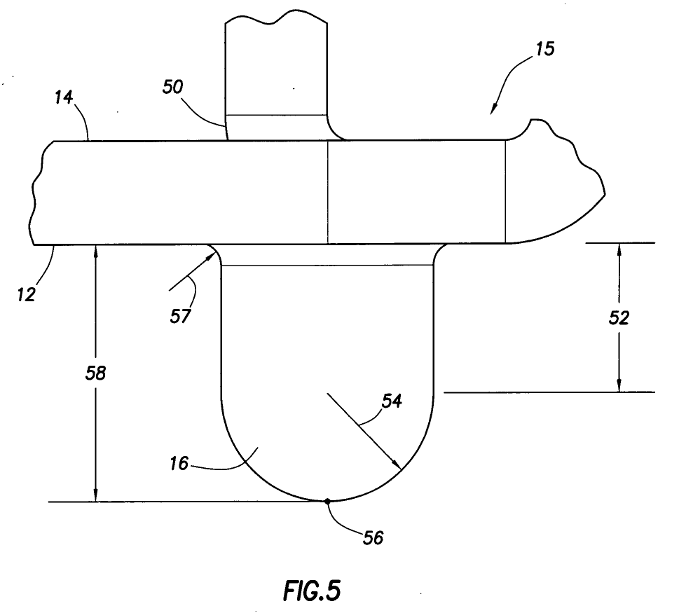

Shown in FIG. 5 is a cross sectional view of dimple 15. The dimple 15 may be pushed out of a sheet of material by a punch 50, which will not likely produce metal shavings or other significant contaminants. In the case of the chassis sidewall 10, the sheet of material may be formed of a lightweight metal. However, it will be recognized that the chassis sidewall 10, or any other sheet of material used to create the alignment form 17, may be formed of other suitable materials. Multiple dimples 15 may be formed in the sheet at a single station in the manufacturing die. In some applications, this may optimize tolerance stack-ups, allowing a favorable mating condition between the hard drive and the backplane.

As the die stamps the sheet of material, a deformation occurs, creating the dimple 15. After the die stamps the sheet of material, the protuberance 16 has a height 52 sufficient for contact with the carrier 30. This height 52 may be as large as about 1.5 mm for a sheet having a width of about 1.0 mm. For example, a sheet of material that is 0.8 mm thick may have protuberances 16 that have the height 52 of 1.32 mm. The protuberance 16 may additionally have a distal end that is rounded with a radius 54, such that a distance 58 from the front face 12 to a contact point 56 is approximately equal to the height 52 plus the radius 54. For example, a radius of 1 mm with a 1.0 mm sheet could correspond to distance 58 of about 2.5 mm. The curved surface created by the radius 54 allows for minimal contact between the protuberance 16 and the carrier 30, while still providing aid in alignment. A base of the protuberance 16 may be transitioned into the front face 12 with radii 57.

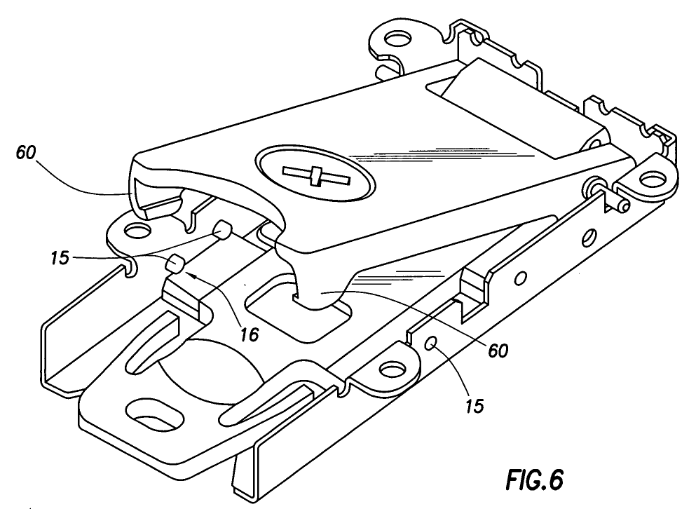

In FIG. 6, a 9G server top cover latch is shown. The dimples 15, and more specifically, the protuberances 16 formed in a piece of material may be used to align tabs 60 therebetween as shown.

The dimples 15 disclosed herein serves as both an aid in the manufacturing process and a precision alignment aid. The present disclosure has been described with reference to chassis 10 and a server top cover latch. It should be recognized, however, that the dimples 15 of the present disclosure may be employed with any other component of the computer system. It should be recognized that the dimples 15 disclosed herein may be used in conjunction with any component of the computer system that allows the component to be aligned precisely when the component is installed in the computer system. Although the present disclosure has been described in detail, it should be understood that various changes, substitutions, and alterations can be made hereto without departing from the spirit and the scope of the invention as defined by the appended claims.

What is claimed is:

1. An alignment form for an information handling system, comprising
a chassis having a sidewall;
one or more dimples formed in the sidewall, the one or more dimples each having a protuberance on a front face of the sidewall;
wherein the one or more dimples are each sized such that the one or more protuberances contact a carrier as it slides into the chassis.

2. The alignment form of claim 1, wherein the one or more dimples comprise at least two dimples.

3. The alignment form of claim 1, wherein the one or more dimples each further has a recession on a rear face of the sidewall.

4. The alignment form of claim 1, wherein the chassis sidewall and the one or more dimples are unitarily formed.

5. The alignment form of claim 1, wherein the one or more protuberances has a height and a radius sufficient for contact with the carrier.

6. The alignment form of claim 5, wherein the height is about 1.5 times a thickness of the sidewall, and the radius is about the same as the thickness of the sidewall, such that contact occurs at a distance from the front face of about 2.5 times the thickness of the sidewall.

7. An alignment form for an information handling system, comprising
a piece of material;
one or more dimples formed in the piece of material, the one or more dimples each having a protuberance on a front face of the piece of material;
wherein the one or more dimples are each sized such that that the one or more protuberances contact a component as it is installed in the information handling system.

8. The alignment form of claim 7, wherein the one or more dimples comprise at least two dimples.

9. The alignment form of claim 7, wherein the one or more dimples each further has a recession on a rear face of the sidewall.

10. The alignment form of claim 7, wherein the piece of material and the one or more dimples are unitary.

11. The alignment form of claim 7, wherein the piece of material is a sheet of material.

12. The alignment form of claim 7, wherein the one or more protuberances has a height and a radius sufficient for contact with the component.

13. The alignment form of claim 12, wherein the height is about 1.5 times a thickness of the piece of material, and the radius is about the same as the thickness of the piece of material, such that contact occurs at a distance from the front face of about 2.5 times the thickness of the piece of material.

14. A method of forming an alignment form for an information handling system, the method comprising
providing a piece of material;
forming one or more dimples in the piece of material, such that the one or more dimples each has a protuberance on a front face of the piece of material;
wherein the one or more dimples are each formed such that that the one or more protuberances may contact a component as it is installed in the information handling system.

15. The method of claim 14, wherein the one or more dimples comprise at least two dimples, and wherein the at least two dimples are formed at the same time.

16. The method of claim 14, wherein the step of forming the one or more dimples comprises pressing a punch into the piece of material.

17. The method of claim 14, wherein the piece of material is a sheet of material.

18. The method of claim 14, wherein the step of forming the one or more dimples comprises the step of deforming the piece of material.

19. The method of claim 14, wherein the one or more protuberances is formed such that a height and a radius are sufficient for contact with the component.

20. The method of claim 19, wherein the height is formed to be about 1.5 times a thickness of the piece of material, and the radius is formed to be about the same as the thickness of the piece of material, such that contact may occur at a distance from the front face of about 2.5 times the thickness of the piece of material.
